(19) United States
(12) Patent Application Publication
(10) Pub. No.: US 2014/0380478 A1
(43) Pub. Date: Dec. 25, 2014

(54) USER CENTRIC FRAUD DETECTION

(71) Applicant: INTERNATIONAL BUSINESS MACHINES CORPORATION, Armonk, NY (US)

(72) Inventors: Simon G. Canning, Upper Coomera (AU); Christopher J. Hockings, Burleigh Waters (AU); Philip A. J. Nye, Southport (AU)

(21) Appl. No.: 14/477,906

(22) Filed: Sep. 5, 2014

Related U.S. Application Data
(63) Continuation of application No. 13/926,865, filed on Jun. 25, 2013.

(51) Int. Cl. H04L 29/06; H04L 29/08

(52) U.S. Cl. CPC H04L 63/1416; H04L 67/18; H04L 67/22
USPC 726/23

(57) ABSTRACT

A computer detects fraudulent access to user accounts of a network application. The computer receives user account usage profile information for a plurality of user accounts. Rules are determined, based in part on the user account profile information, that define account usage patterns across two or more user accounts that identify fraudulent user account usage. The computer receives user account usage event information for a plurality of user accounts. Based on the determined rules, the computer identifies fraudulent user account usage patterns in the user account usage event information and transmits a security alert to the user accounts associated with the identified fraudulent user account usage pattern.

### FIELD OF THE INVENTION

The present invention relates generally to information security and more particularly to attack prevention and intrusion detection across cloud or internet services.

### BACKGROUND OF THE INVENTION

The Internet provides a user access to a wide range of network applications. Such applications can include social networking services, such as Facebook, Twitter, or LinkedIn, and e-mail services such as Gmail. Other applications may include cloud resources such as cloud computing and cloud storage services like iCloud or Blue Cloud. (Facebook, Twitter, LinkedIn, Gmail, iCloud, and Blue Cloud are trademarks of their respective owners.) It is becoming common for hackers, or those who exploit security weaknesses in computer systems and networks, to target these Internet applications with the intention of inflicting reputational or financial damage to the user, or for personal gain.

Phishing is the act of attempting to acquire information, such as user names, passwords, and credit card details, by masquerading as a trustworthy entity in an electronic communication. Spear phishing is a phishing attempt directed at specific individuals or companies in which attackers attempt to gather personal information about their target to increase their probability of success. Social engineering is the art of manipulating people into performing actions or divulging confidential information. This is a type of confidence trick for the purpose of information gathering, fraud, or unauthorized computer system access.

### SUMMARY

Embodiments of the present invention provide for a computer program product, system, and method for detecting fraudulent access to user accounts of a network application. A computer receives user account usage profile information for a plurality of user accounts. Rules are determined, based in part on the user account profile information, that define account usage patterns across two or more user accounts that identify fraudulent user account usage. The computer receives user account usage event information for a plurality of user accounts. Based on the determined rules, the computer identifies fraudulent user account usage patterns in the user account usage event information and transmits a security alert to the user accounts associated with the identified fraudulent user account usage pattern.

### BRIEF DESCRIPTION OF THE SEVERAL VIEWS OF THE DRAWINGS

FIG. 1 is a block diagram illustrating a fraud detection system, in accordance with an embodiment of the present invention.

FIG. 2 is a flowchart showing the operational steps of a user registration process of the fraud detection system of FIG. 1, in accordance with an embodiment of the present invention.

FIG. 3 is a flowchart showing the operational steps of a fraud detection monitor of the fraud detection system of FIG. 1, in accordance with an embodiment of the present invention.

FIG. 4 shows a block diagram of components of the fraud detection server of the fraud detection system of FIG. 1, in accordance with an embodiment of the present invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable medium(s) having computer readable program code/instructions embodied thereon.

Any combination of computer-readable media may be utilized. Computer-readable media may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of a computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java®, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks.

Embodiments of the present invention generally describe a fraud detection system that identifies coordinated attack sequences across a set of network based user accounts. The present invention will now be described in detail with reference to the Figures.

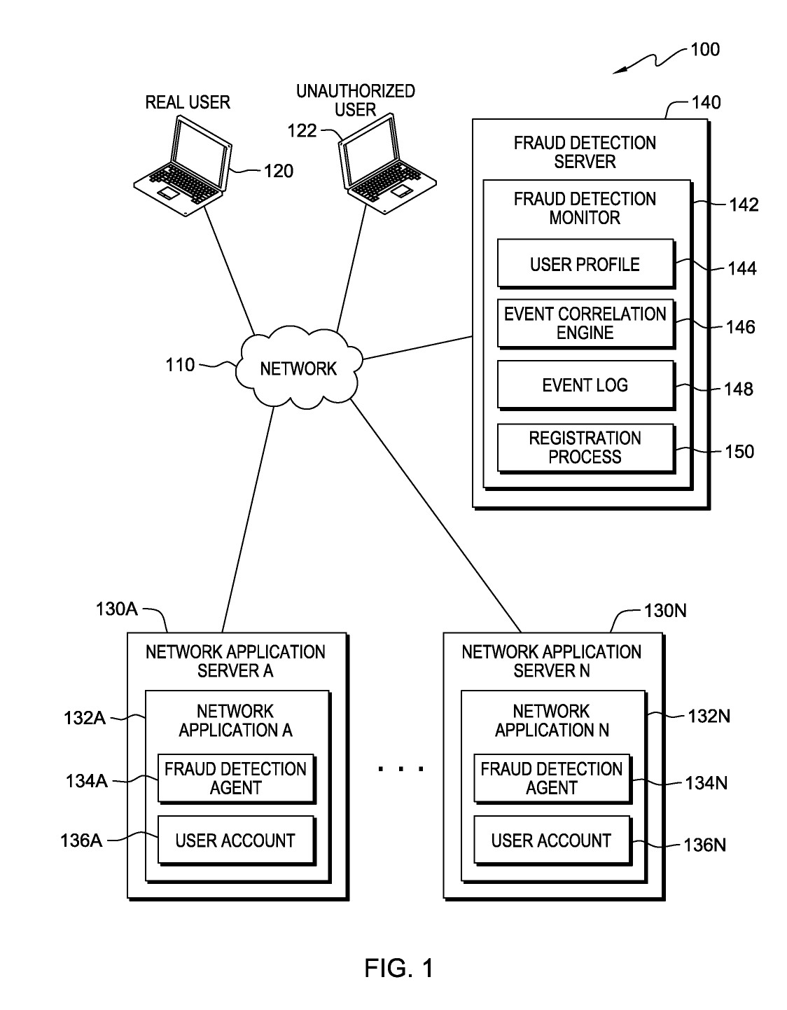

FIG. 1 is a block diagram illustrating fraud detection system 100, in accordance with an embodiment of the present invention. In an exemplary embodiment, fraud detection system 100 includes real user 120, unauthorized user 122, network application servers 130A to 130N, and fraud detection server 140, all interconnected via network 110.

Network 110 can be, for example, a local area network (LAN), a wide area network (WAN) such as the Internet, or a combination of the two, and can include wired, wireless, or fiber optic connections. In general, network 110 can be any combination of connections and protocols that will support communications between real user 120 and unauthorized user 122, and network application servers 130A to 130N and fraud detection server 140.

Network application servers 130A to 130N include network applications 132A to 132N which represent network based services, typically accessed through a web browser or mobile application, that perform some function for the user, such as communication, commerce, entertainment, data processing or data storage. Examples of network applications 132A to 132N include, but are not limited to, e-mail service providers, social networking services, cloud computing providers, and cloud storage providers. A user, for example, real user 120, typically creates a user account 136 on a network application 132 by defining a login ID and a password. Many of these network applications 132 request a user's email address as the login ID.

Unauthorized user 122 represents one or more hackers, automated processes, systems, or combinations thereof that attempt to access or use user accounts 136 of network application 132 belonging to an authorized user, for example, real user 120. The use of a common login user name, such as the user's email address, across multiple network applications 132 can facilitate an attack sequence against user accounts 136 belonging to real user 120 by unauthorized user 122.

One example of an attack sequence includes the “reset password” function. This function is typically used when a user cannot remember the password to a network application. This function typically requires entry of the user name, and answering one or more security questions. The answer to such commonly used security questions, such as pet names, place of birth, school mascot, or favorite movie may be publicly known, for example, from public databases or a user's Facebook page, or can be obtained through phishing, spear phishing or social engineering techniques. The attack sequence may start, for example, with unauthorized user 122 accessing e-mail user account 136 of real user 120 using a “reset password” function, and answering the one or more security questions based on public information or information obtained, as described above. After accessing e-mail user account 136 of real user 120, unauthorized user 122 can quickly gain access to other user accounts 136 of real user 120 using a “forgot password” function. The “forgot password” function typically sends a password notification e-mail to a user's e-mail account. Having access to e-mail user account 136 of real user 120, the attacker can then specify a new password, or ask that a randomly generated password be provided. Unauthorized user 122 now has access to e-mail account and multiple user accounts 136 of real user 120 using newly acquired passwords. Real user 120 may have no knowledge of the newly created passwords, restricting his or her access to the accounts. Unauthorized user 122 may then use data mining of e-mail or other user accounts 136 of real user 120, to obtain additional personal account information. An attack such as just described could take place in a matter of minutes, and unauthorized user 122 could have full access to all user accounts 136 of real user 120.

In preferred embodiments of the present invention, each network application 132 includes a fraud detection agent 134. Fraud detection agent 134, in an exemplary embodiment, is a program module that sends real-time security notifications to fraud detection server 140 that are related to user account usage events, such as security events, in the network application 132 with which a fraud detection agent 134 is associated. A security event is a user or application-initiated event that affects access rights and access control to a network application 132. A security event can be, but is not limited to, login, log out, change password, incorrect login, account lockout due to too many incorrect password attempts, or password reset request. The notification to fraud detection server 140 includes, but is not limited to, network application 132 identifier, user account identifier, login IP address, geographic location of the device initiating the security event, identifier of the device initiating the security event, and a timestamp. For example, responsive to a login request to a network application 132, the associated fraud detection agent 134 generates a notification to fraud detection server 140 containing information about the login request including the IP address of the device attempting to login, for example, real user 120 or unauthorized user 122, the login device identifier, the geographic location of the login device, and the date and time of the login request. In other embodiments, as described in more detail below, a fraud detection agent 134 may receive an alert from fraud detection server 140 indicating the existence of a possible security threat, and take certain actions, for instance, sending commands to network application 132 increasing the security requirements for security events associated with user account 136.

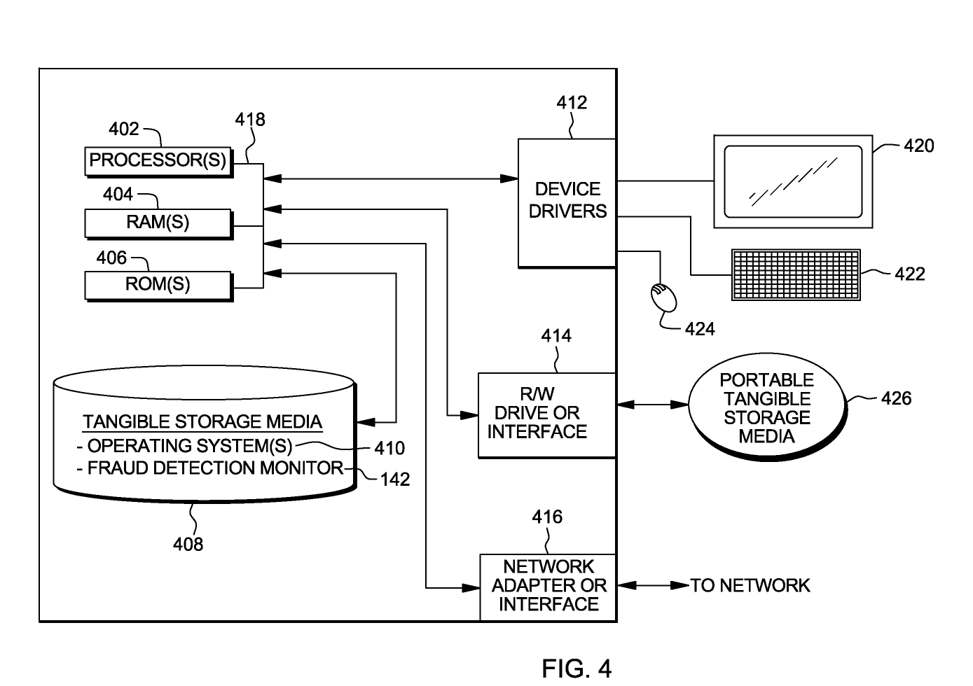

Fraud detection server 140 includes fraud detection monitor 142. In various embodiments, fraud detection server 140, which is described in more detail below with respect to FIG. 4, can be a laptop computer, a tablet computer, a netbook computer, a personal computer (PC), a desk top computer, a mainframe computer, a networked server computer, or any programmable electronic device capable of accessing network 110 and capable of executing the functionality required of an embodiment of the invention.

Fraud detection monitor 142 operates to receive and analyze the security event notifications from the fraud detection agents 134 associated with the network applications 132 of the multiple user accounts 136 of real user 120. Fraud detection monitor 142 includes user profile 144, event correlation engine 146, event log 148, and registration process 150. Event log 148 stores the event data derived from the security notifications transmitted by fraud detection agent 134 and received by fraud detection monitor 142. Thus, the security event information generated by each user account 136 of real user 120 network applications 132 is collected in event log 148.

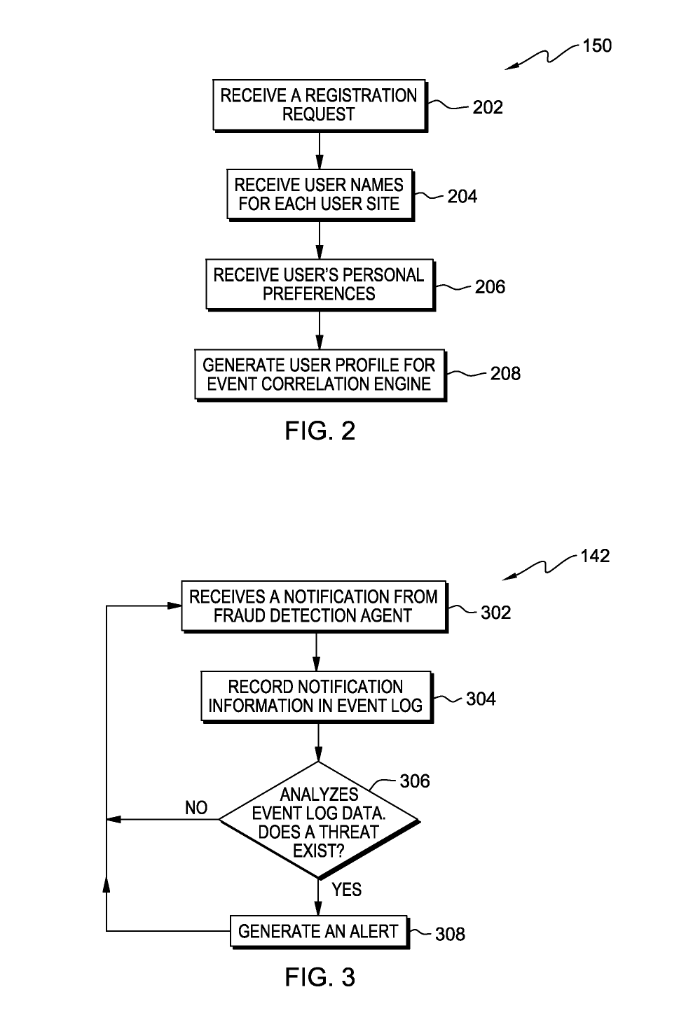

User profile 144 represents profile information associated with the user accounts 136 of network application 132 of real user 120. The profile information is generated by fraud detection monitor 142 based on user input received during registration process 150, as described in more detail below with respect to FIG. 2. The profile information for real user 120 includes, for example, a list of user accounts 136 of real user 120, the user name for each of the user accounts 136, real user's 120 travel locations, travel frequency, devices, physical home location, and typical usage times.

Event correlation engine 146 is a rules-based event processing system that receives and correlates event data derived from the security notifications transmitted by fraud detection agents 134 that is stored in event log 148 by fraud detection monitor 142. Event correlation engine 146 identifies possible security threats and generates warnings of possible security threats based on analysis of the event data. In an exemplary embodiment, fraud detection rules are generated by an event correlation system when a user has completed the registration process, as described below. The rules define fraudulent user account usage patterns that include security events of two or more of the user accounts 136. For example, based on a user's registration input, a rule set may be generated that will trigger an alert when security events occur in substantially different geographic locations.

In preferred embodiments, event correlation engine 146 is configured to detect fraudulent user account usage patterns based on the security event records from multiple, disparate network applications. Event correlation engine 146 analyzes the security event records of event log 148 based on the generated rules to identify the existence of a security threat. Responsive to a detected security threat, event correlation engine 146 generates a warning.

Responsive to the warning of a security threat generated by event correlation engine 146, fraud detection monitor 142 generates an alert. The alert is, for example, a communication sent to real user 120 indicating the existence of a possible security threat against one or more of the user accounts 136 of real user 120. In an exemplary embodiment, the communication is a text message or e-mail sent to the real user's mobile telephone or other user device as specified in user profile 144. In other embodiments, fraud detection monitor 142 sends alerts to all fraud detection agents 134 associated with user accounts 136 of real user 120, indicating the existence of a possible security threat. Responsive to a received alert, a fraud detection agent 134 may, for example, increase the security requirements for transactions affecting access rights or access control to user accounts 136 of real user 120, or may lock all user accounts 136 of real user 120.

FIG. 2 is a flowchart showing the operational steps of registration process 150 in fraud detection monitor 142 of FIG. 1, in accordance with an embodiment of the present invention. Registration process 150 receives a registration request from a user, for example, real user 120, via, for example, a web interface (step 202). Registration process 150 receives a list of the user accounts 136 and user names for real user 120 to be registered for the user accounts 136 (step 204). Authorization is provided by real user 120 to each of the registered network application 132 of real user's 120 user accounts 136 that allow the network application 132 to push security event notifications to fraud detection monitor 142. For example, the open standard authorization protocol (OAuth) may be used to provide this authorization.

Fraud detection monitor 142 receives real user's 120 personal preferences (step 206). The personal preferences may be received in response to a set of questions provided by fraud detection monitor 142. In various embodiments, fraud detection monitor 142 provides one or more menus allowing real user 120 to select personal preferences, usage habits and desired options that will be used by event correlation engine 146. The user inputs include, but are not limited to, user's travel habits, devices, home location, and typical usage times. The user inputs also include the user's preferred notification method or methods. For example, real user 120 can choose to be notified of a security threat by an e-mail sent to two different e-mail addresses and also by a text message sent to a mobile phone account. In an exemplary embodiment, real user 120 specifies the actions to be taken by fraud detection agents 134 responsive to a security threat notification. Fraud detection monitor 142 generates user profile 144 that will be used by event correlation engine 146 based on the user input received by real user 120 during registration process 150 (step 208).

FIG. 3 is a flowchart showing the operational steps of fraud detection monitor 142 within fraud detection system 100 of FIG. 1, in accordance with an embodiment of the present invention. Fraud detection monitor 142 receives a notification of a security event from a fraud detection agent 134 (step 302). The notification can be from any of the fraud detection agents 134 of network applications 132 containing a user account 136 registered by real user 120. The security event notification can result from an event initiated by real user 120 or unauthorized user 122. After fraud detection monitor 142 receives a security event notification from fraud detection agent 134, the fraud detection monitor records the information of the security event in event log 148 (step 304). As such, event log 148 contains security event information from the fraud detection agents 134 of the multiple registered network applications of user accounts 136 of real user 120, and further, event log 148 contains security event information for events initiated by real user 120 and unauthorized user 122.

Fraud detection monitor 142 then analyzes the data of event log 148 to determine if a threat exists (decision 306). Event correlation engine 146 analyzes the information of event log 148, based on its generated rules, to determine the existence of abnormal activities or abnormal patterns indicating a potential threat. If event correlation engine 146 determines that a threat does not exist (decision 306, “No” branch), fraud detection monitor waits to receive the next security event notification (step 302). If event correlation engine 146 determines a threat does exist and creates a warning indicating a threat does exist (decision 306, “Yes” branch), fraud detection monitor 142 generates an alert (step 308), and then waits to receive the next security event notification (step 302).

For example, fraud detection monitor 142 receives a notification from fraud detection agent 134 of a “reset password” request for an e-mail user account 136 registered by real user 120 (step 302), and records the information related to the “reset password” request in event log 148 (step 304). Event correlation engine 146 analyzes event log 148 and determines, based on rules generated as part of the registration process 150, that this single event does not represent a threat. Therefore no alert is generated (step 306, “No” branch). Subsequently, five minutes later, fraud detection monitor 142 receives a notification from fraud detection agent 134 of a “forgot password” request for a social network user account 136 registered by real user 120 (step 302), and records the information related to the “forgot password” request in event log 148 (step 304). Event correlation engine 146 analyzes event log 148 and determines, based on the generated rules, that the sequence of a “reset password” followed by a “forgot password” request occurring within a defined span of time across two disparate network applications registered by real user 120 represents abnormal behavior, and creates a warning (step 306, “Yes” branch).

In another example, fraud detection monitor 142 receives a notification from fraud detection agent 134 of a login request for an e-mail user account 136 registered by real user 120 (step 302), and records the information related to the login request in event log 148 (step 304). Event correlation engine 146 analyzes event log 148 and determines, based on the generated rules, that this single event does not represent a threat, therefore no alert is generated (step 306, “No” branch). Subsequently, fraud detection monitor 142 receives a notification from fraud detection agent 134 of a login request for a financial user account 136 registered by real user 120 (step 302), and records the information related to the login request in event log 148 (step 304). Event correlation engine 146 analyzes event log 148 and determines that the device used to initiate the subsequent login request is located in a different city from the e-mail account login location. Event correlation engine 146 determines, based on the generated rules, that the login request initiated from a device in a different geographic location represents abnormal behavior, and creates a warning (step 306, “Yes” branch).

In another embodiment, event correlation engine 146 analyzes the alerts across all of the registered user accounts 136 of all of the registered real users 120, based on its generated rules, to determine the existence of abnormal activities or abnormal patterns indicating a potential threat. For example, event correlation engine 146 determines that the number of alerts generated for a specific network application 136, for instance g-mail, exceeds a threshold of 5% of all registered g-mail user accounts 136 within a span of 15 minutes, represents abnormal behavior, and generates a warning.

As described above, responsive to the creation of a warning of a security threat by event correlation engine 146, (decision 306, “Yes” branch), fraud detection monitor 142 generates an alert (step 308). In various embodiments, the alert is a communication sent to real user 120. The communication can be a message indicating the security threat sent via a short message service (SMS) as specified by real user 120 in user profile 144 or the communication can be an e-mail sent to one or more e-mail accounts specified by real user 120 in user profile 144. In an exemplary embodiment, the alert is sent by fraud detection monitor 142 to fraud detection agents 134 wherein the fraud detection agents 134 increase the security requirements affecting access rights and access control to the registered user accounts 136 of network application 132. For example, event correlation engine 146, having determined that a sequence of a “reset password” followed by a “forgot password” request occurring within a defined span of time across two disparate user accounts 136 registered by real user 120 represents a threat, generates a warning (step 306, “Yes” branch). Responsive to the warning, fraud detection monitor 142 sends a text message to real user 120 indicating the “forgot password” request. Additionally, in an exemplary embodiment, fraud detection monitor 142 sends an alert to fraud detection agent 134 wherein the fraud detection agent 134 sends a command to network application 132 to block the “forgot password” request. In addition, fraud detection monitor 142 sends an alert to each one of the fraud detection agents 134 of network applications 132, wherein the fraud detection agent 134 sends a command to network application 132 to increase the security requirements by requiring additional security questions for requests affecting access rights and access control to user accounts 136 (step 308).

FIG. 4 shows a block diagram of components of the fraud detection server 140 of fraud detection system 100 of FIG. 1, in accordance with an embodiment of the present invention. It should be appreciated that FIG. 4 provides only an illustration of one implementation and does not imply any limitations with regard to the environments in which different embodiments may be implemented. Many modifications to the depicted environment may be made.

Fraud detection server 140 can include one or more processors 402, one or more computer-readable RAMs 404, one or more computer-readable ROMs 406, one or more tangible storage media 408, device drivers 412, read/write drive or interface 414, and network adapter or interface 416, all interconnected over a communications fabric 418. Communications fabric 418 can be implemented with any architecture designed for passing data and/or control information between processors (such as microprocessors, communications and network processors, etc.), system memory, peripheral devices, and any other hardware components within a system.

One or more operating systems 410 and fraud detection monitor 142 are stored on one or more of the computer-readable tangible storage media 408 for execution by one or more of the processors 402 via one or more of the respective RAMs 404 (which typically include cache memory). In the illustrated embodiment, each of the computer-readable tangible storage media 408 can be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage medium that can store a computer program and digital information.

Fraud detection server 140 can also include a R/W drive or interface 414 to read from and write to one or more portable computer-readable tangible storage media 426. Fraud detection monitor 142 can be stored on one or more of the portable computer-readable tangible storage media 426, read via the respective R/W drive or interface 414 and loaded into the respective computer-readable tangible storage medium 408.

Fraud detection server 140 can also include a network adapter or interface 416, such as a TCP/IP adapter card for communications via a cable, or a wireless communication adapter. Fraud detection monitor 142 can be downloaded to the computing device from an external computer or external storage device via a network (for example, the Internet, a local area network or other, wide area network or wireless network) and network adapter or interface 416. From the network adapter or interface 416, the programs are loaded into the computer-readable tangible storage medium 408. The network may include copper wires, optical fibers, wireless transmission, routers, firewalls, switches, gateway computers and/or edge servers.

Fraud detection server 140 can also include a display screen 420, a keyboard or keypad 422, and a computer mouse or touchpad 424. Device drivers 412 interface to display screen 420 for imaging, to keyboard or keypad 422, to computer mouse or touchpad 424, and/or to display screen 420 for pressure sensing of alphanumeric character entry and user selections. The device drivers 412, R/W drive or interface 414 and network adapter or interface 416 can comprise hardware and software (stored in computer-readable tangible storage media 408 and/or ROM 406).

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

Based on the foregoing, a computer system, method, and program product have been disclosed for a presentation control system. However, numerous modifications and substitutions can be made without deviating from the scope of the present invention. Therefore, the present invention has been disclosed by way of example and not limitation.

What is claimed is:

1. A method for detecting fraudulent access to user accounts of a network application, the method comprising:
receiving, by one or more processors, user account usage profile information for a plurality of user accounts;
determining, by one or more processors, at least one rule, based at least in part on the user account usage profile information, that defines a fraudulent user account usage pattern that includes user account usage events of two or more user accounts;
receiving, by one or more processors, user account usage event information for a plurality of user accounts;
identifying, by one or more processors, the fraudulent user account usage pattern in the received user account usage event information, based on the determined rules; and
transmitting, by one or more processors, a security alert to the user accounts associated with the identified fraudulent user account usage pattern.

2. A method in accordance with claim 1, wherein user account usage profile information includes one or more of: user account login ID's, user devices, physical home location, travel frequency, travel locations, and typical usage times.

3. A method in accordance with claim 1, wherein received user account usage event information includes one or more of: device identifier, device IP address, a geographic location, and a timestamp.

4. A method in accordance with claim 1, wherein the plurality of user accounts are associated with a single user.

5. A method in accordance with claim 1, wherein received account usage event information is stored in an event log.
